(19) United States
(12) Patent Application Publication
(10) Pub. No.: US 2018/0170242 A1
(43) Pub. Date: Jun. 21, 2018

(54) BLUETOOTH-ENABLED VEHICLE LIGHTING CONTROL HUB

(71) Applicant: Pilot, Inc., City of Industry, CA (US)

(72) Inventor: Calvin Shiening Wang, City of Industry, CA (US)

(21) Appl. No.: 15/870,658

(22) Filed: Jan. 12, 2018

Related U.S. Application Data
(63) Continuation-in-part of application No. 15/383,148, filed on Dec. 19, 2016.

(51) Int. Cl. B60Q 1/06; H04W 4/80; H04L 29/08

(52) U.S. Cl. CPC B60Q 1/06; H04W 4/80; B60Q 2300/21; B60Q 2300/05; H04L 67/125

(57) ABSTRACT

A Bluetooth-enabled lighting control hub allows a user to activate and adjust one or more lighting devices associated with a vehicle through a mobile device in wireless communication with the lighting control hub. The lighting control hub receives instructions from the mobile device, generates a control signal, and transmits the control signal to the lighting device in question.

### CROSS-REFERENCE TO RELATED APPLICATIONS

This application is a continuation-in-part of U.S. patent application Ser. No. 15/383,148, entitled “VOICE-ACTIVATED VEHICLE LIGHTING CONTROL HUB,” which was filed on Dec. 19, 2016 and is hereby incorporated by reference herein for all purposes.

### FIELD OF THE DISCLOSURE

The present disclosure relates to systems for controlling the operation of lights installed in or on a vehicle, and more particularly to systems for providing wireless control of the operation of lights installed in or on a vehicle.

### BACKGROUND

Automotive vehicles are traditionally equipped with external lighting, including headlights and taillights, for the safety of those both inside and outside of the vehicle. For example, headlights allow a vehicle operator to see along the vehicle's path of travel and avoid obstacles in that path, while both headlights and taillights make the vehicle more visible and noticeable to persons outside of the vehicle (including operators of other vehicles). Many other types of lights may be installed in or on a vehicle, including for example external fog lamps, grill lights, light bars, beacons, flashing lights, internal dome lights, reading lights, visor lights, and foot-well lights. These and other types of lights may be installed in a vehicle as manufactured or as an aftermarket addition to or modification of the vehicle. Such lights may be utilitarian (e.g. flashing lights on an emergency vehicle, or spotlights for illuminating a work area near the vehicle) or decorative (e.g. neon underbody lights, internal or external accent lights).

### SUMMARY

Many passenger vehicles, as manufactured, have one switch or dial that controls the headlights, taillights, and other external lights, as well as separate switches for each of the car's interior lights (or for groupings thereof). As a result, a vehicle operator may need to turn on the vehicle's external lights with one hand and using a first switch, then turn on one internal light with another hand and using a second switch located apart from the first switch, then turn on a second internal light with either hand but using a third switch located apart from the first and second switches. If aftermarket lighting has been installed on the vehicle, then such lighting may be controlled by one or more additional switches. As a result, the operation of the vehicle's lighting is decentralized and generally inconvenient for the operator. Indeed, using present systems, an operator wishing to activate or deactivate a light must remove at least one hand from the steering wheel, then divert his or her attention from outside the vehicle to inside the vehicle to locate and activate the appropriate switch for the light in question. Depending on the location of the switch for the light at issue, the operator may have to contort his or her body to reach the desired switch from the driver's seat, or stop the vehicle, exit the vehicle, and access the light switch in question from another door or other access point of the vehicle. Beyond inconveniencing the operator, these steps may present safety concerns to the extent they result in the operator diverting his or her attention from the road or other drive path of the vehicle.

Still further, aftermarket lighting may require stringing a control wire from the lighting device itself (which may be outside the vehicle) to the area surrounding the driver. This may require time-consuming installation, modification of existing vehicle components to create a path for the wire, and/or aesthetically displeasing arrangements (e.g. if the wire in question is visible from the passenger cabin or on the exterior of the vehicle).

The present disclosure provides a solution for the problems of and/or associated with decentralized vehicle lighting control, distracted driving due to light operation, difficulty of accessing light switches from the driver's seat, and wired control switch installation.

A lighting control hub according to one embodiment of the present disclosure comprises: a command unit comprising a Bluetooth® (Bluetooth® is a registered trademark of the Bluetooth Special Interest Group) transceiver; a processing unit comprising a processor and a computer-readable memory storing instructions for execution by the processor; a wireless communication unit; and a power management unit configured to provide power to at least the processing unit in a first low-power sleep mode and in a second operational mode. The instructions, when executed by the processor, cause the processor to: recognize an input; exit the first low-power sleep mode and enter the second operational mode; process signals received via the command unit; generate a control signal responsive to the processed instructions; and transmit the control signal via the wireless communication unit.

The input may be received via the command unit. The signals received via the command unit may correspond to one or more settings of the lighting control hub. The instructions, when executed by the processor, may further cause the processor to: transmit, via the command unit, information about an initial status of at least one lighting device. The instructions, when executed by the processor, may further cause the processor to: receive, via the command unit, a selection signal identifying a selected lighting device from a plurality of lighting devices. The signals received via the command unit may correspond to the selected lighting device. The control signal may correspond to a command to change a status of the selected lighting device. The status may correspond to one of a power state of the lighting device, a color of light generated by the lighting device, a flashing sequence of the lighting device, a position of the lighting device, an orientation of the lighting device, and an intensity of light generated by the lighting device. The power management unit may comprise a 12-volt adapter for connection of the lighting control hub to a 12-volt power receptacle. The lighting control hub may further comprise an LED indicator, and the instructions, when executed by the processor, may further cause the processor to provide an indication, via the LED indicator, that the lighting control hub is in the second operational mode.

According to another embodiment of the present disclosure, a method of controlling a lighting device comprises: establishing a communication channel, via a Bluetooth transceiver of a lighting control hub, between the lighting control hub and a mobile device; receiving, via the Bluetooth transceiver, a first signal corresponding to a selection of a lighting device controllable by the lighting control hub; transmitting, via the Bluetooth transceiver, a second signal comprising information about a plurality of available options for the selected lighting device; receiving, via the Bluetooth transceiver, a third signal corresponding to a selection of at least one option from the plurality of available options; generating, with a processor of the lighting control hub, a control signal based on the at least one option; and transmitting the control signal to the selected lighting device.

The lighting device may be one of a plurality of lighting devices controllable by the lighting control hub. The plurality of available options may comprise an option corresponding to at least one of a power state of the lighting device, a color of light generated by the lighting device, a flashing sequence of the lighting device, and an intensity of light generated by the lighting device. The plurality of available options may comprise an option corresponding to at least one of a position of the lighting device and an orientation of the lighting device. The lighting device may be controllable by the lighting control hub via a receiver in electronic communication with the lighting device. The lighting control hub may transmit the control signal to the selected lighting device via the receiver, and the lighting control hub may transmit the control signal to the receiver wirelessly. The lighting control hub may transmit the control signal to the receiver wirelessly via a wireless communication interface separate from the Bluetooth transceiver. The method may further comprise transmitting, via the Bluetooth transceiver, a fourth signal corresponding to a status of the lighting device.

According to still another embodiment of the present disclosure, a lighting control system for a vehicle comprises a hub and a receiver. The hub comprises: a processor; a non-transitory computer-readable memory storing instructions for execution by the processor; a Bluetooth transceiver; and a first wireless transceiver. The receiver comprises: a microcontroller; a second wireless transceiver; and a lighting device interface. The instructions for execution by the processor, when executed by the processor, cause the processor to: receive, via the Bluetooth transceiver, a signal corresponding to a desired setting of a lighting device connected to the lighting device interface; generate a control signal, based on the signal, for adjusting the lighting device to have the desired setting; and cause the first wireless transceiver to transmit the control signal to the second wireless transceiver.

The desired setting may correspond to one or more of a power state of the lighting device, a color of light generated by the lighting device, a flashing sequence of the lighting device, a position of the lighting device, an orientation of the lighting device, and an intensity of light generated by the lighting device. The microcontroller may comprise a second processor and a second computer-readable memory storing second instructions for execution by the second processor. The second instructions, when executed by the second processor, may cause the second processor to: receive the control signal via the second wireless transceiver; send, via the lighting device interface, a command signal based on the control signal; and transmit a confirmation signal via the second wireless transceiver, wherein the confirmation signal comprises a present status of a lighting device connected to the lighting device interface.

The terms “computer-readable medium” and “computer-readable memory” are used interchangeably and, as used herein, refer to any tangible, non-transitory storage medium that participates in providing instructions to a processor for execution. Such a medium may take many forms, including but not limited to non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable medium is configured as a database, it is to be understood that the database may be any type of database, such as relational, hierarchical, object-oriented, and/or the like. Accordingly, the disclosure is considered to include a tangible, non-transitory storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a voice-activated control hub according to one embodiment of the present disclosure;

FIG. 2 is a flowchart of a method according to another embodiment of the present disclosure;

FIG. 3 is a block diagram of a voice-activated control hub and associated receiver according to a further embodiment of the present disclosure;

FIG. 4 is a flowchart of a method according to yet another embodiment of the present disclosure;

FIG. 5 is a flowchart of a method according to still another embodiment of the present disclosure;

FIG. 6 is a block diagram of a Bluetooth-enabled lighting control hub according to a further embodiment of the present disclosure;

FIG. 7 is a flowchart of a method according to a still further embodiment of the present disclosure;

FIG. 8 is a block diagram of a Bluetooth-enabled lighting control hub and associated receiver and mobile device according to a yet further embodiment of the present disclosure; and

FIG. 9 is a flowchart of a method according to an even further embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

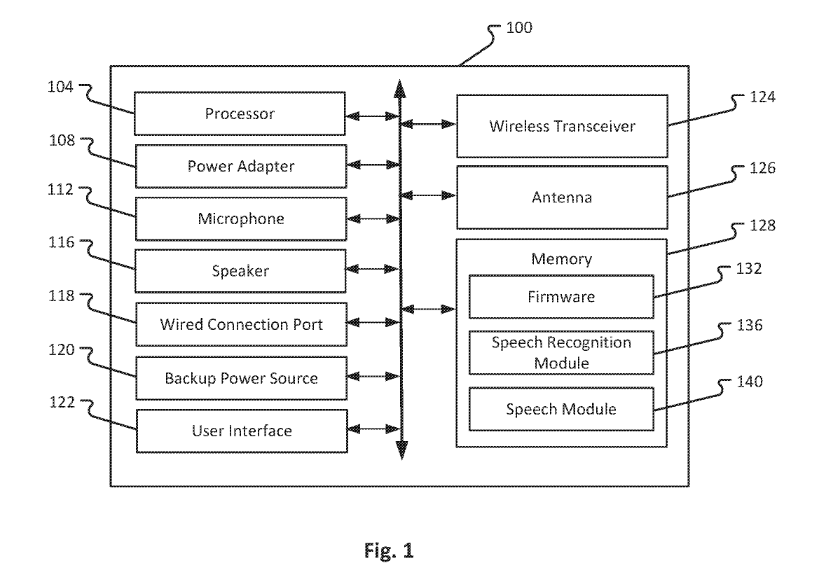

Referring first to FIG. 1, a voice-activated lighting control hub 100 according to an embodiment of the present disclosure comprises a processor 104, a power adapter 108, a microphone 112, a speaker 116, one or more wired connection ports 118, a backup power source 120, a user interface 122, a wireless transceiver 124 coupled to an antenna 126, and a memory 128.

The processor 104 may correspond to one or multiple microprocessors that are contained within a housing of the voice-activated lighting control hub 100. The processor 104 may comprise a Central Processing Unit (CPU) on a single Integrated Circuit (IC) or a few IC chips. The processor 104 may be a multipurpose, programmable device that accepts digital data as input, processes the digital data according to instructions stored in its internal memory, and provides results as output. The processor 104 may implement sequential digital logic as it has internal memory. As with most known microprocessors, the processor 104 may operate on numbers and symbols represented in the binary numeral system.

The power adapter 108 comprises circuitry for receiving power from an external source, such as a 12-volt automobile power receptacle, and accomplishing any signal transformation, conversion or conditioning needed to provide an appropriate power signal to the processor 104 and other components of the hub 100. For example, the power adapter 108 may comprise one or more DC to DC converters for converting the incoming signal (e.g., an incoming 12-volt signal) into a higher or lower voltage as necessary to power the various components of the hub 100. Not every component of the hub 100 necessarily operates at the same voltage, and if different voltages are necessary, then the power adapter 108 may include a plurality of DC to DC converters. Additionally, even if one or more components of the hub 100 do operate at the same voltage as the incoming power signal (e.g. 12 volts), the power adapter 100 may condition the incoming signal to ensure that the power signal(s) being provided to the other components of the hub 100 remains within a specific tolerance (e.g. plus or minus 0.5 volts) regardless of fluctuations in the incoming power signal. In some embodiments, the power supply 108 may also include some implementation of surge protection circuitry to protect the components of the hub 100 from power surges.

The power adapter 108 may also comprise circuitry for receiving power from the backup power source 120 and carrying out the necessary power conversion and/or conditioning so that the backup power source 120 may be used to power the various components of the hub 100. The backup power source 120 may be used, for example, to power an uninterruptible power supply to protect against momentary drops in the voltage provided by the main power source.

The microphone 112 is used to receive verbal commands regarding control of one or more vehicle lighting systems. The microphone 112 may be any type of microphone suitable for detecting and recording verbal commands in a vehicle, where there may be high levels of ambient noise. The microphone 112 may be, for example, an electret microphone. The microphone 112 may also be a cardioid or other directional microphone, for limiting the detection of unwanted noise. The microphone 112 may comprise noise-cancelling or noise-filtering features, for cancelling or filtering out noises common to the driving experience, including such noises as passenger voices, air conditioning noises, tire noise, engine noise, radio noise, and wind noise. In some embodiments, the hub 100 may comprise a plurality of microphones 112, which may result in an improved ability to pick up verbal commands and/or to filter out unwanted noise.

In some embodiments, the microphone 112 is contained within or mounted to a housing of the hub 100, while in other embodiments the microphone 112 may be external to and separate from the hub 100, and connected thereto via a wired or wireless connection. For example, a microphone 112 may be plugged into a wired connection port 118 of the hub 100. Alternatively, the hub 100 may be configured to pair with an external microphone 112 using the wireless transceiver 124, via a wireless communication protocol such as Wi-Fi, Bluetooth®, Bluetooth Low Energy (BLE), ZigBee, MiWi, FeliCa, Weigand, or a cellular telephone interface. In this way, the microphone 112 may be positioned closer to the mouth of a user of the hub 100, where it can more readily detect verbal commands uttered by the user.

The speaker 116 is used by the hub 100 to provide information to a user of the hub 100. For example, if a user requests a status update on one or more lighting systems in a vehicle, the requested information may be spoken to the user by a computer generated voice via the speaker 116. As with the microphone 112, the speaker 116 may be contained within or mounted to a housing of the hub 100 in some embodiments. In other embodiments, however, the speaker 116 may be external to a housing of the hub 100, and may be connected thereto via a wired or wireless connection. For example, a wire (e.g. a USB cable or a 3.5 mm audio cable) may be used to connect the wired connection port 118 of the hub 100 to an input port of the vehicle in which the hub 100 is utilized, such that the hub 100 simply utilizes the speakers of the vehicle as the speaker 116. As another example, the wireless transceiver 124 may be used to connect to an infotainment system of the vehicle, or to a headset or earpiece worn by an operator of the vehicle, using a wireless communication protocol such as Wi-Fi, Bluetooth®, Bluetooth Low Energy (BLE), ZigBee, MiWi, FeliCa, Weigand, or a cellular telephone interface. In this manner, the speaker(s) of the vehicle infotainment system, or of the headset or earpiece worn by the operator, may be used as the speaker 116. In still other embodiments, the hub 100 may comprise both an in-housing speaker 116 and an ability to be connected to an external speaker 116, to provide maximum flexibility to a user of the hub 100.

The voice-activated lighting control hub 100 also comprises a backup power source 120. The backup power source 120 may be, for example, one or more batteries (e.g. AAA batteries, AA batteries, 9-volt batteries, lithium ion batteries, button cell batteries). The backup power source 120 may be used to power the hub 100 in a vehicle having no 12-volt power receptacle, or to provide supplemental power if the power obtained by the power adapter 108 from the external power source is insufficient.

A user interface 122 is further provided with the hub 100. The user interface allows a user of the hub 100 to “wake up” the hub 100 prior to speaking a verbal command into the microphone 112 of the hub 100. The user interface 122 may be in the form of a button, switch, sensor, or other device configured to receive an input, and/or it may be a two-way interface such as a touchscreen, or a button, switch, sensor, or other input device coupled with a light or other output device. The user interface 122 beneficially facilitates the placement of the hub in a low power or “sleeping” state when not in use. When a user provides an input via the interface 122, the hub 100 wakes up. One or both of a visual indication and an audio indication may confirm that the device is awake and ready to receive a command. For example, if the user interface 122 comprises a light, the light may illuminate or may turn from one color (e.g. red) to another (e.g. green). Additionally or alternatively, the processor 104 may cause the speaker 116 to play a predetermined audio sequence indicating that the hub 100 is ready to receive a command, such as “Yes, master?”. Once a user awakens the hub 100 by providing an input via the user interface 122, the hub 100 may remain awake for a predetermined period of time (e.g. fifteen seconds, or thirty seconds, or forty-five seconds, or a minute). The predetermined period of time may commence immediately after the hub 100 is awakened, or it may commence (or restart) once a command is received. The latter alternative beneficially allows a user to provide a series of commands without having to awaken the hub 100 by providing an input via the user interface 122 prior to stating each command.

The wireless transceiver 124 comprises hardware that allows the hub 100 to transmit and receive commands and data to and from one or more lighting devices (not shown), as well as (in some embodiments) one or both of a microphone 112 and/or a speaker 116 (e.g. in embodiments where the microphone 112 and/or speaker 116 may be external to and separate from the hub 100). The primary function of the wireless transceiver 124 is to interact with a wireless receiver or transceiver in communication with one or more lighting devices installed in or on the vehicle in which the hub 100 is being used. The wireless transceiver 124 therefore eliminates the need to route wiring from a lighting device (which may be on the exterior of the vehicle) to a control panel inside the vehicle and within reach of the vehicle operator, and further eliminates any aesthetic drawbacks of such wiring. Instead, the hub 100 can establish a wireless connection with a given lighting device using the wireless transceiver 124, which connection may be used to transmit commands to turn the lighting device's lights on and off, and/or to control other features of the lighting system (e.g. flashing sequence, position, orientation, color). As noted above, the wireless transceiver 124 may also be used for receiving data from a microphone 112 and/or for transmitting data to a speaker 116.

The wireless transceiver 124 may comprise a Wi-Fi card, a Network Interface Card (NIC), a cellular interface (e.g., antenna, filters, and associated circuitry), an NFC interface, an RFID interface, a ZigBee interface, a FeliCa interface, a MiWi interface, Bluetooth interface, a BLE interface, or the like.

The memory 128 may correspond to any type of non-transitory computer-readable medium. In some embodiments, the memory 128 may comprise volatile or non-volatile memory and a controller for the same. Non-limiting examples of memory 128 that may be utilized in the hub 100 include RAM, ROM, buffer memory, flash memory, solid-state memory, or variants thereof.

The memory 128 stores any firmware 132 needed for allowing the processor 104 to operate and/or communicate with the various components of the hub 100, as needed. The firmware 132 may also comprise drivers for one or more of the components of the hub 100. In addition, the memory 128 stores a speech recognition module 136 comprising instructions that, when executed by the processor 104, allow the processor 104 to recognize one or more commands in a recorded audio segment, which commands can then be carried out by the processor 104. Further, the memory stores a speech module 140 comprising instructions that, when executed by the processor 104, allow the processor 104 to provide spoken information to an operator of the hub 100.

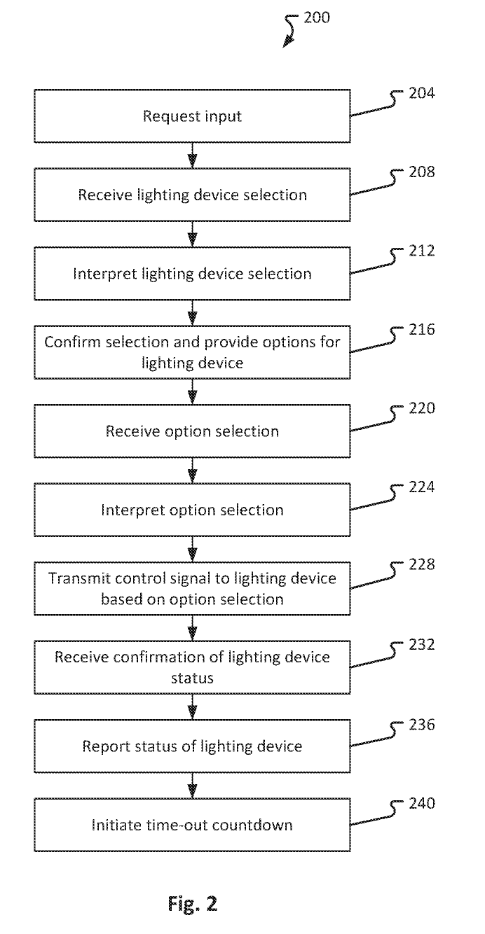

With reference now to FIG. 2, a voice-activated lighting control hub 100 according to the present disclosure may be operated according to a method 200. In the following description of the method 200, reference may be made to actions or steps carried out by the hub 100, even though the action or step is carried out only by a specific component of the hub 100.

After the hub 100 has received an input via the user interface 122 that causes the hub 100 to wake up out of a low-power, sleeping mode, the hub 100 requests input from a user (step 204). The request may be in the form of causing the speaker 116 to play a computer-generated voice asking, for example, “Yes, master?”. Other words or phrases may also be used, including, for example, “What would you like to do?” or “Ready.” In some embodiments, the request may be replaced or supplemented by a simple indication that the hub 100 is ready to receive a command, such as by changing the color of an indicator light provided with the user interface 122, or by generating an audible beep using the speaker 116.

The hub 100 receives a lighting device selection (step 208). The user makes a lighting device selection by speaking the name of the lighting device that the user would like to control. For example, the lighting device selection may comprise receiving and/or recording a lighting device name such as “accent light” or “light bar” or “driving lights.” The name of each lighting device controllable with the hub 100 may be preprogrammed by a manufacturer of the lighting device and transmitted to the hub 100 during an initial configuration/pairing step between the hub 100 and the lighting device in question, or the name of a lighting device may be programmed by the user during an initial configuration/pairing step between the hub 100 and the lighting device in question.

Upon receipt of the lighting device selection, the hub 100 interprets the lighting device selection (step 212). More specifically, the processor 104 executes the speech recognition module 136 to translate or otherwise process the verbal lighting device selection into a computer-readable input or instruction corresponding to the selected lighting device. Alternatively, the processor 104 may execute the speech recognition module 136 to compare the verbal lighting device selection with a prerecorded or preprogrammed set of lighting device names, identify a match, and select a computer-readable input or instruction corresponding to the matched lighting device.

Once the hub 100 has identified the selected lighting device, the hub 100, via the speaker 116, confirms the selected lighting device and presents to the user available options for that lighting device. More specifically, the processor 104 retrieves from the memory 128 information about the current status of the selected lighting device and the other available statuses of the selected lighting device, and causes the speaker 116 to play a computer-generated voice identifying the current status of the selected lighting device and/or the other available statuses of the selected lighting device. For example, if the user selects “accent light” in step 204, then the hub 100 may respond with “Yes, master. Accent light here. Do you want steady, music, flash, or rainbow?” Alternatively, if the user selects “headlights” in step 204, and the headlights are currently on, then the hub 100 may respond with “The headlights are on. Would you like high-beams?” or “You selected headlights. Would you like to activate high-beams or turn the headlights off?” As evident from these examples, the hub 100 may be programmed to adopt a conversational tone with a user (e.g. by using full sentences and responding to each command with an acknowledgment (e.g. “yes, master”) before requesting additional input. Alternatively, the hub 100 may be programmed only to convey information. In such an embodiment, the hub 100 may say, for example, “Accent light. Steady, music, flash, or rainbow?” or “Headlights on. High-beams or off?”

In some embodiments, obvious options (e.g. “on” or “off”) are not provided by the hub 100 at step 216, even though one or more such options may always be available. Also in some embodiments, the hub 100 may be programmed to automatically turn on any selected lighting device, so that a user does not have to select a lighting device and then issue a separate command to turn on that lighting device.

The hub 100 next receives an option selection (step 220). As with step 208, this occurs by receiving and/or recording, via the microphone 112, a verbal command from a user. For example, if the selected lighting device is the accent light and the provided options were steady, music, flash, and rainbow, the hub 100 may receive an option selection of “steady,” or of “music,” or of “flash,” or of “rainbow.” As noted above, in some embodiments, obvious options may not be explicitly provided to the user, and in step 220 the user may select such an option. For example, rather than select one of the four provided options (music, steady, flash, or rainbow), the user may say “off” or “change color.”

Once the hub 100 has received an option selection at step 220, the hub 100 interprets the option selection (step 224). As described above with respect to interpreting the lighting device selection in step 212, interpreting the option selection may comprise the processor 104 executing the speech recognition module 136 to translate or otherwise process the verbal option selection into a computer-readable input or instruction corresponding to the selected option. Alternatively, the processor 104 may execute the speech recognition module 136 to compare the verbal option selection with a prerecorded, preprogrammed, or otherwise stored set of available options, identify a match, and select a computer-readable input or instruction corresponding to the matched option.

In step 228, the hub 100 executes the computer-readable code or instruction identified in step 224, which causes the hub 100 to transmit a control signal to a particular lighting device based on the selected option. For example, if the command is “flash,” the hub 100 may transmit a wireless signal to a receiver in electronic communication with the accent light instructing the accent light to flash. If the command is “music,” the hub 100 may transmit a wireless signal to a receiver in electronic communication with the accent light instructing the accent light to pulse according to the beat of music being played by the vehicle's entertainment or infotainment system. If the command is “high beams” for the headlights, then the hub 100 may transmit a wireless signal to a receiver in electronic communication with the headlights, instructing the headlights to switch from low-beams to high-beams. The hub 100 may also be configured to recognize compound option selections. For example, the command may be “change color and flash,” which may cause the hub 100 to transmit a wireless signal to a receiver in electronic communication with the accent light that instructs the accent light to change to the next color in sequence and to begin flashing.

After transmitting a control signal to the selected lighting device corresponding to the selected option in step 228, the hub 100 waits to receive a confirmation signal from the lighting device (step 232). The confirmation signal may be a generic acknowledgment that a command was received and carried out, or it may be a more specific signal describing the current state of the lighting device (e.g. on, off, high-beam, low-beam, flashing on, flashing off, color red, color green, color purple, color blue, music, steady, rainbow).

In step 236, the hub 100 reports to the user the status of the lighting device from which the confirmation signal was received. As with other communications to the user, the report is provided in spoken format via the speaker 116 using a computer-generated voice. The report may be, for example, a statement similar to the command, such as “flashing” or “accent light steady.” Alternatively, the report may be more generic, such as “command executed.” In still another alternative, the report may give the present status of the lighting device in question, such as “the accent light is now red” or “the accent light is now green.” In some embodiments, the user may have the option to turn such reporting on or off, and/or to select the type of reporting the user desires to receive.

After reporting the status of the lighting device in step 236, the hub 100 initiates a time-out countdown (step 240). This may comprise initiating a countdown timer, or it may comprise any other known method of determining tracking when a predetermined period of time has expired. If the time-out countdown concludes without receiving any additional input from the user, then the hub 100 returns to its low-power sleeping mode. If the user does provide additional input before the time-out countdown concludes, then the hub 100 repeats the appropriate portion of the method 200 (e.g. beginning at step 208 if the additional input is a light device selection or at step 220 if the additional input is an option selection for the previously selected lighting device).

In some embodiments of the present disclosure, a voice-activated lighting control hub according to embodiments of the present disclosure may not include a user interface 122, but may instead constantly record and analyze audio received via the microphone 112. In such embodiments, the hub may be programmed to analyze the incoming audio stream for specific lighting device names or option selections, or to recognize a specific word or phrase (or one of a plurality of specific words of phrases) as indicative that a command will follow. The specific word or phrase may be, for example, a name of the hub 100 (e.g. “Control Hub”), or the name of a lighting device, such as “light bar,” or “accent light.” The word or phrase may be preprogrammed upon manufacture of the hub 100, or it may be programmable by the user. The word or phrase may be a name of the hub 100 (whether that name is assigned by the manufacturer or chosen be a user). When the hub 100 continuously analyzes incoming audio, the hub 100 may continuously record incoming audio (which may be discarded or recorded over once the audio has been analyzed and found not to include a command, or once a provided command has been executed), or may record audio only when a word or phrase trigger is detected.

According to alternative embodiments of the present disclosure, the hub 100 may be programmed or otherwise configured to receive and respond to audio commands. An audio command in such embodiments may include (1) an identification of the lighting device having a state that the commanding user would like to change; and (2) an identification of the change the user would like to make. This two-pronged format may not be needed or utilized where the hub 100 controls only one lighting device, and/or where the lighting device in question has only two possible states (e.g. on/off). However, if for example the hub 100 controls a plurality of lighting devices (e.g. fog lamps, underbody accent lights, and a roof-mounted light bar), and where one or more of the lighting devices may be controlled in more ways than just being turned on and off (e.g. by changing an intensity of a light of the lighting device, a direction in which the lighting device is pointed, an orientation of the lighting device, a flashing sequence of the lighting device, a color of the light emitted from the lighting device, a position of the lighting device (e.g. raised/lowered)), the two-pronged format for audio commands may be useful or even necessary.

In addition to receiving input intended for control of a lighting device, the voice-activated lighting control hub 100 may also be programmed to recognize audio commands regarding control of the hub 100 itself. For example, before the hub 100 can transmit commands to a lighting device, the hub 100 may need to be paired with or otherwise connected to the lighting device. The hub 100 may therefore receive commands causing the hub 100 to enter a discoverable mode, or causing the hub 100 to pair with another device in a discoverable mode, or causing the hub 100 to record connection information for a particular lighting device. Additionally, the hub 100 may be programmed to allow a user to record specific commands in his or her voice, to increase the likelihood that the hub 100 will recognize and respond to such commands correctly. Still further, the hub 100 may be configured to recognize commands to change a trigger word or phrase to be said by the user prior to issuing a command to the hub 100, or to record a name for a lighting device. As an alternative to programming conducted by speaking verbal commands to the hub 100, a user may program or otherwise configure the hub 100 using the user interface 122, particularly if the user interface 122 comprises a touchscreen adapted to display information via text or in another visual format.

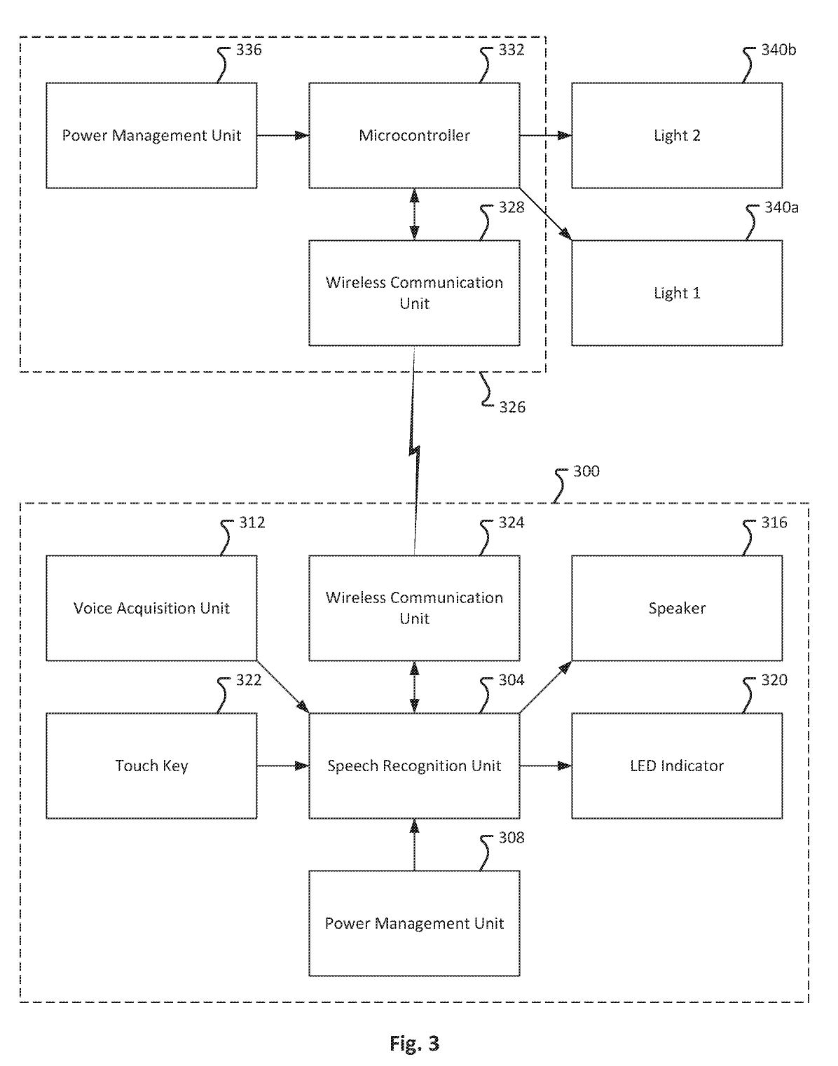

Turning now to FIG. 3, a voice-activated lighting control hub 300 according to yet another embodiment of the present disclosure comprises a speech recognition unit 304, a power management unit 308, a voice acquisition unit 312, a speaker 316, an LED indicator 320, a touch key 322, and a wireless communication unit 324. The voice-activated lighting control hub 300 communicates wirelessly with a receiver 326 that comprises a wireless communication unit 328, a microcontroller 332, and a power management unit 336. The receiver 326 may be connected (via a wired or wireless connection) to one or more lights 340a, 340b.

Speech recognition unit 304 may comprise, for example, a processor coupled with a memory. The processor may be identical or similar to the processor 104 described in connection with FIG. 1 above. Likewise, the memory may be identical or similar to the memory 128 described in connection with FIG. 1 above. The memory may store instructions for execution by the processor, including instructions for analyzing digital signals received from the voice acquisition unit 312, identifying one or more operations to conduct based on an analyzed digital signal, and generating and transmitting signals to one or more of the speaker 316, the LED indicator 320, and the wireless communication unit 324. The memory may also store instructions for execution by the processor that allow the processor to generate signals corresponding to a computer-generated voice (e.g. for playback by the speaker 316), for communication of information or of prompts to a user of the hub 300. The memory may further store information about the lights 340a, 340b that may be controlled using the hub 300.

The power management unit 308 handles all power-related functions for the hub 300. These functions include receiving power from a power source (which may be, for example, a vehicle 12-volt power receptacle; an internal or external battery; or any other source of suitable power for powering the components of the hub 300), and may also include transforming power signals to provide an appropriate output voltage and current for input to the speech recognition unit 304 (for example, from a 12-volt, 10 amp received power signal to a 5-volt, 1 amp output power signal), and/or conditioning an incoming power signal as necessary to ensure that it meets the power input requirements of the speech recognition unit 304. The power management unit 308 may also comprise a battery-powered uninterruptible power supply, to ensure that the output power signal thereof (e.g. the power signal input to the speech recognition unit 304) does not vary with fluctuations in the received power signal (e.g. during engine start if the power signal is received from a vehicle's 12-volt power receptacle).

The voice acquisition unit 312 receives voice commands from a user and converts them into signals for processing by the speech recognition unit 304. The voice acquisition unit 312 may comprise, for example, a microphone and an analog-to-digital converter. The microphone may be identical or similar to the microphone 112 described in connection with FIG. 1 above.

The speaker 316 may be identical or similar to the speaker 116 described in connection with FIG. 1 above. The speaker 316 may be used for playback of a computer-generated voice based on signals generated by the speech recognition unit 304, and/or for playback of one or more non-verbal sounds (e.g. beeps, buzzes, or tones) at the command of the speech recognition unit 304.

The LED indicator 320 and the touch key 322 provide a non-verbal user interface for the hub 300. The speech recognition unit 304 may cause the LED indicator to illuminate with one or more colors, flashing sequences, and/or intensities to provide one or more indications to a user of the hub 300. For example, the LED indicator may display a red light when the hub 300 is in a low power sleep mode, and may switch from red to green to indicate to a user that the hub 300 has awakened out of the low power sleep mode and is ready to receive a command. Indications provided via the LED indicator 320 may or may not be accompanied by playback of a computer-generated voice by the speaker 316. For example, when the hub 300 wakes up out of a low power sleep mode, the LED indicator may change from red to green and the speech recognition unit 304 may cause a computer-generated voice to be played over the speaker 316 that says “yes, master?” As another example, the LED indicator 320 may flash a green light when it is processing a command, and may change from a low intensity to a high intensity when executing a command.

The touch key 322 may be depressed by a user to awaken the hub 300 out of a low power sleep mode, and/or to return the hub 300 to a low power sleep mode. Inclusion of a touch key negates any need for the hub 300 to continuously listen for a verbal command from a user, which in turn reduces the amount of needed processing power of the speech recognition unit 304 and also allows the hub 300 to enter a low power mode when not actually in use.

The hub 300 also includes a wireless communication unit 324, which may be identical or similar to the wireless transceiver 124 described in connection with FIG. 1 above.

The hub 300 communicates wireless with a receiver 326. The receiver 326 comprises a wireless communication unit 328, which like wireless communication unit 324, may be identical or similar to the wireless transceiver 124 described in connection with FIG. 1 above. The wireless communication unit 328 receives signals from the wireless communication unit 324, which it passes on to the microcontroller 332. The wireless communication unit 328 also receives signals from the microcontroller 332, which it passes on to the wireless communication unit 324.

The microcontroller 332 may comprise, for example, a processor and a memory, which processor and memory may be the same as or similar to any other processor and memory, respectively, described herein. The microcontroller 332 may be configured to receive one or more signals from the hub 300 via the wireless communication unit 328, and may further be configured to respond to such signals by sending information to the hub 300 via the wireless communication unit 328, and/or to generate a control signal for controlling one or more features of a light 340a, 340b. The microcontroller 332 may also be configured to determine a status of a light 340a, 340b, and to generate a signal corresponding to the status of the light 340a, 340b, which signal may be sent to the hub 300 via the wireless communication unit 328. Still further, the microcontroller 332 may be configured to store information about the one or more lights 340a, 340b, including, for example, information about the features thereof and information about the current status or possible statuses thereof.

The power management unit 336 comprises an internal power source and/or an input for receipt of power from an external power source (e.g. a vehicle battery or vehicle electrical system). The power management unit 336 may be configured to provide substantially the same or similar functions as the power management unit 308, although power management unit 336 may have a different power source than the power management unit 308, and may be configured to transform and/or condition a signal from the power source differently than the power management unit 308. For example, the power management unit 308 may receive power from a vehicle battery or vehicle electrical system, while the power management unit 336 may receive power from one or more 1.5-volt batteries, or from one or more 9-volt batteries. Additionally, the power management unit 336 may be configured to output a power signal having a voltage and current different than the power signal output by the power management unit 308.

The receiver 326 is controllably connected to one or more lights 340a, 340b. The microcontroller 326 generates signals for controlling the lights 340a, 340b, which signals are provided to the lights 340a, 340b to cause an adjustment of a feature of the lights 340a, 340b. In any given vehicle, one receiver may control one lighting device in the vehicle, or a plurality of lighting devices in the vehicle, or all lighting devices in the vehicle. Additionally, when one receiver does not control every lighting devices in the vehicle, additional receivers may be used in connection with each lighting device or group of lighting devices installed in or on the vehicle. The lights 340a, 340b may be any lights or lighting devices installed in or on the vehicle, including for example, internal lights, external lights, headlights, taillights, running lights, fog lamps, accent lights, spotlights, light bars, dome lights, and courtesy lights.

In some embodiments, where a single receiver 326 is connected to a plurality of lights 340a, 340b, a single verbal command (e.g. “Turn on all external lights”) may be used to cause the receiver 326 to send a “turn on” command to all lights 340a, 340b controlled by that receiver 326. Alternatively, where a car uses a plurality of receivers 326 to control a plurality of lights 340a, 340b in and on the vehicle, a single verbal command (e.g. “Turn off all lights”) may be used to cause the hub 300 to send a “turn off” command to each receiver 326, which command may then be provided to each light 340a, 340b attached to each receiver 326. In other embodiments, each light 340a, 340b must be controlled independently, regardless of whether the lights 340a, 340b are connected to the same receiver 326.

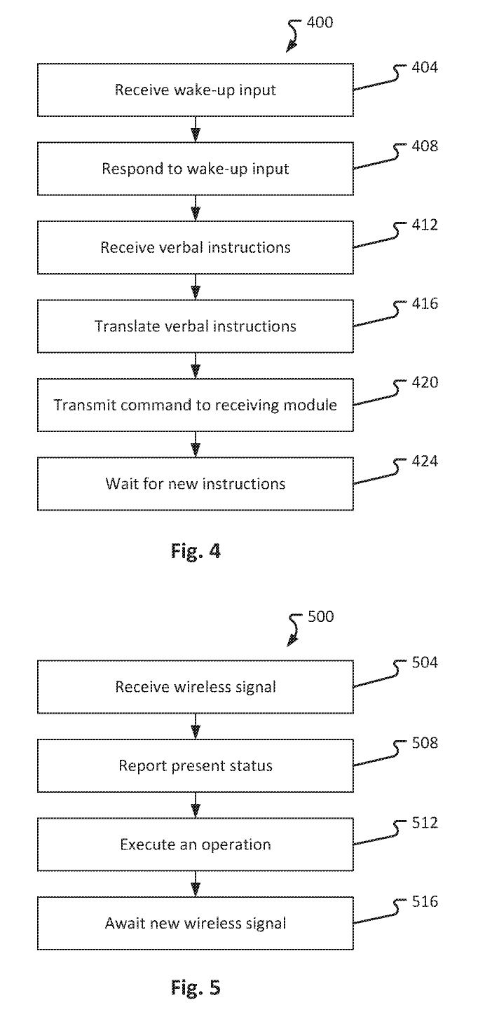

FIGS. 4 and 5 depict methods 400 and 500 according to additional embodiments of the present disclosure. Although the following description of the methods 400 and 500 may refer to the hub 100 or 300 or to the receiver 326 performing one or more steps, persons of ordinary skill in the art will understand that one or more specific components of the hub 100 or 300 or the receiver 326 performs the step(s) in question.

In the method 400, the hub 100 or 300 receives a wake-up or an initial input (step 404). The wake-up input may comprise, for example, a user pressing the touch key 322 of the hub 300 or interacting with the user interface 122 of the hub 100. In some embodiments, the wake-up input may comprise a user speaking a specific verbal command, which may be a name of the hub 100 or of the hub 300 (whether as selected by the manufacturer or as provided by the user), or any other predetermined word or phrase.

The hub 100 or 300 responds to the wake-up input (step 408). The response may comprise requesting a status update of one or more lighting devices from one or more receivers 326, or simply checking the memory 128 or a memory within the speech recognition unit 304 of the hub 300 for a stored status of the one or more lighting devices. Additionally or alternatively, the response may comprise displaying information to the user via the user interface 122 or the LED indicator 320. For example, the hub 100 or 300 may cause an LED light (e.g. the LED indicator 320) to change from red to green as an indication that the wake-up input has been received. Still further, the response may comprise playing a verbal response (e.g. using a computer-generated voice) over the speaker 116 or 316. The verbal response may be a simple indication that that hub 100 or 300 is awake, or that the hub 100 or 300 received the wake-up input. Or, the verbal response may be a question or prompt for a command, such as “yes, master?”.

The hub 100 or 300 receives verbal instructions from the user (step 412). The verbal instructions are received via the microphone 112 of the hub 100 or via the voice acquisition unit 312 of the hub 300. The verbal instructions may be converted into a digital signal and sent to the processor 104 or to the speech recognition unit 304, respectively.

The processor translates or otherwise processes the signal corresponding to the verbal instructions (step 416). The translation or other processing may comprise, for example, decoding the signal to identify a command contained therein, or comparing the signal to each of a plurality of known signals to identify a match, then determining which command is associated with the matching known signal. The translation or other processing may also comprise decoding the signal to obtain a decoded signal, then using the decoded signal to look up an associated command (e.g. using a lookup table stored in the memory 128 or other accessible memory).

The command may be any of a plurality of commands corresponding to operation of a lighting device and/or to operation of the control hub. For example, the command may relate to turning a lighting device on or off; adjusting the color of a lighting device; adjusting a flashing setting of a lighting device; adjusting the position or orientation of a lighting device; or adjusting the intensity or brightness of a lighting device.

The hub 100 or 300 transmits the command to a receiving module, such as the receiver 326 (step 420). The command may be transmitted using any protocol disclosed herein or another suitable protocol. A protocol is suitable for purposes of the present disclosure if it enables the wireless transmission of information (including data and/or commands).

In some embodiments, the hub 100 or 300 may receive from the receiving module, whether before or after transmitting the command to the receiving module, information about the status of the receiving module. This information may be provided to the user by, for example, using a computer-generated voice to convey the information over the speaker 116 or 316. The information may be provided as confirmation that received instructions were carried out, or to provide preliminary information to help a user decide which instruction(s) to issue.

Once the command has been carried out, the hub 100 or 300 awaits new instructions (step 424). The hub 100 or 300 may time-out and enter a low-power sleep mode after a given period of time, or it may stay on until turned off by a user (whether using a verbal instruction or via the user interface 122 or touch key 322). If the hub 100 or 300 does receive new instructions, then the method 400 recommences at step 412 (or 416, once the instructions are received).

The method 500 describes the activity of a receiver 326 according to an embodiment of the present disclosure. The receiver 326 receives a wireless signal (step 504) from the hub 100 or the hub 300. The wireless signal may or may not request information about the present status of one or more lighting devices 340a, 340b attached thereto, but regardless, the receiver 326 may be configured to report the present status of the one or more lighting devices 340a, 340b (step 508). Reporting the present status of the one or more lighting devices 340a, 340b may comprise, for example, querying the lighting devices 340a, 340b, or it may involve querying a memory of the microcontroller 332. The reporting may further comprise generating a signal corresponding to the present status of the lighting devices 340a, 340b, and transmitting the signal to the hub 100 or 300 via the wireless communication unit 328.

The received signal may further comprise instructions to perform an operation, and the receiver 326 may execute the operation at step 512. This may involve using the microcontroller to control one or more of the lighting devices 340a, 340b, whether to turn the one or more of the lighting devices 340a, 340b on or off, or to adjust them in any other way described herein or known in the art.

After executing the operation, the receiver 516 awaits a new wireless signal (step 516). The receiver 326 may enter a low-power sleep mode if a predetermined amount of time passes before a new signal is received, provided that the receiver 326 is equipped to exit the low-power sleep mode upon receipt of a signal (given that the receiver 326, at least in some embodiments, does not include a user interface 122 or touch key 322). If a new wireless signal is received, then the method 500 recommences at step 504 (or step 508, once the signal is received).

It should be appreciated that the embodiments of the present disclosure need not be connected to the Internet or another wide-area network to conduct speech recognition or other functions described herein. The hubs 100 and 300 have stored in a computer-readable memory therein the data and instructions necessary to recognize and process verbal instructions.

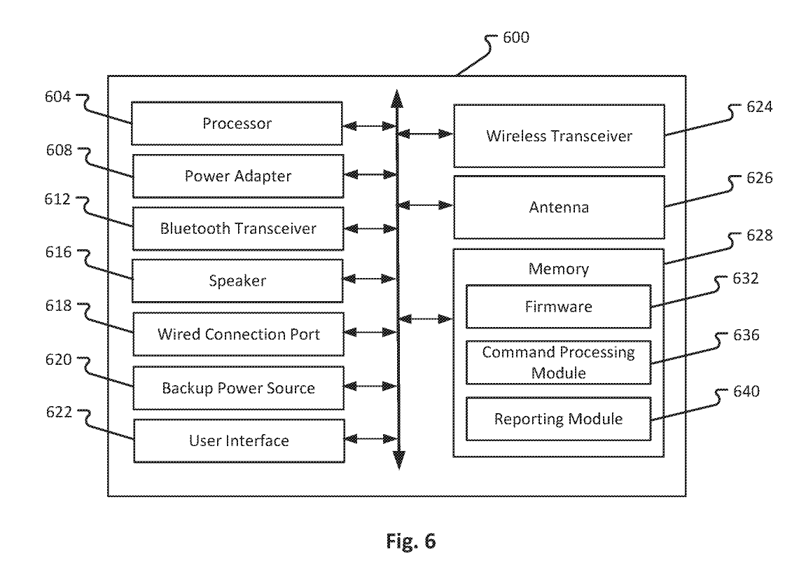

Referring now to FIG. 6, a Bluetooth®-enabled lighting control hub 600 according to an embodiment of the present disclosure comprises a processor 604, a power adapter 608, a Bluetooth® transceiver 612, a speaker 616, one or more wired connection ports 618, a backup power source 620, a user interface 622, a wireless transceiver 624 coupled to an antenna 626, and a memory 628.

The processor 604 may correspond to one or multiple microprocessors that are contained within a housing of the voice-activated lighting control hub 600. The processor 604 may comprise a Central Processing Unit (CPU) on a single Integrated Circuit (IC) or a few IC chips. The processor 604 may be a multipurpose, programmable device that accepts digital data as input, processes the digital data according to instructions stored in its internal memory, and provides results as an output. The processor 604 may implement sequential digital logic as it has internal memory. As with most known microprocessors, the processor 604 may operate on numbers and symbols represented in the binary numeral system.

The power adapter 608 comprises circuitry for receiving power from an external source, such as a 12-volt automobile power receptacle, and accomplishing any signal transformation, conversion or conditioning needed to provide an appropriate power signal to the processor 604 and other components of the hub 600. For example, the power adapter 608 may comprise one or more DC to DC converters for converting the incoming signal (e.g., an incoming 12-volt signal) into a higher or lower voltage as necessary to power the various components of the hub 600. Not every component of the hub 600 necessarily operates at the same voltage, and if different voltages are necessary, then the power adapter 608 may include a plurality of DC to DC converters. Additionally, even if one or more components of the hub 600 do operate at the same voltage as the incoming power signal (e.g. 12 volts), the power adapter 608 may condition the incoming signal to ensure that the power signal(s) being provided to the other components of the hub 600 remains within a specific tolerance (e.g. plus or minus 0.5 volts) regardless of fluctuations in the incoming power signal. In some embodiments, the power supply 608 may also include some implementation of surge protection circuitry to protect the components of the hub 600 from power surges.

The power adapter 608 may also comprise circuitry for receiving power from the backup power source 620 and carrying out the necessary power conversion and/or conditioning so that the backup power source 620 may be used to power the various components of the hub 600. The backup power source 620 may be used, for example, to power an uninterruptible power supply to protect against momentary drops in the voltage provided by the main power source.

The Bluetooth® transceiver 612 is used to receive commands at the hub 600 from a Bluetooth®-enabled mobile device, where the commands pertain to operation of one or more lighting devices (not shown) or of the hub 600 itself. In some embodiments, the Bluetooth® transceiver 612 may also be used to transmit information to the Bluetooth®-enabled mobile device. Such information may include, for example, status information about one or more lighting devices, information about the strength of signals received from the Bluetooth®-enabled mobile device (which may be relevant, for example, for persons wishing to control one or more vehicle lighting devices from outside of the vehicle), and/or information about options or controls available for a given lighting device (e.g. flashing sequence, position, orientation, color, intensity). The Bluetooth® transceiver 612 may utilize any iteration of the Bluetooth® specification, including but not limited to Bluetooth® 5.0 and/or Bluetooth® Low Energy (BLE).

In some embodiments, the Bluetooth® transceiver 612 is contained within or mounted to a housing of the hub 600. Also in some embodiments, the Bluetooth® transceiver 612 may be incorporated into the wireless transceiver 624, to reduce the number of components of the hub 600.

Some embodiments of the hub 600 comprise a speaker 616. The speaker 616 is used by the hub 600 to provide audible information to a user of the hub 600. For example, if a user requests (by causing a mobile device to send an appropriate command to the Bluetooth® transceiver 612) a status update on one or more lighting systems in a vehicle, the requested information may be spoken to the user by a computer-generated voice via the speaker 616. The speaker 616 may be contained within or mounted to a housing of the hub 600 in some embodiments. In other embodiments, however, the speaker 616 may be external to a housing of the hub 600, and may be connected thereto via a wired or wireless connection. In some embodiments, a wire (e.g. a USB cable or a 3.5 mm audio cable) may be used to connect the wired connection port 618 of the hub 600 to an auxiliary input port of the vehicle in which the hub 600 is utilized, such that the hub 600 simply utilizes the speakers of the vehicle as the speaker 616. In other embodiments, the wireless transceiver 624 may be used to connect to an infotainment system of the vehicle, or to a headset or earpiece worn by an operator of the vehicle, using a wireless communication protocol such as Wi-Fi, Bluetooth®, BLE, ZigBee, MiWi, FeliCa, Weigand, or a cellular telephone interface. In this manner, the speaker(s) of the vehicle infotainment system, or of the headset or earpiece worn by the operator, may be used as the speaker 616. In still other embodiments, the hub 600 may comprise both an in-housing speaker 616 and an ability to be connected to an external speaker 616, to provide maximum flexibility to a user of the hub 600.

The Bluetooth®-enabled lighting control hub 600 also comprises a backup power source 620. The backup power source 620 may be, for example, one or more batteries (e.g. AAA batteries, AA batteries, 9-volt batteries, lithium ion batteries, button cell batteries). The backup power source 620 may be used to power the hub 600 in a vehicle having no 12-volt power receptacle, or to provide supplemental power if the power obtained by the power adapter 608 from the external power source is insufficient.

A user interface 622 is further provided with the hub 600. The user interface 622 may be in the form of a button, switch, sensor, or other device configured to receive an input, and/or it may be a two-way interface such as a touchscreen, or a button, switch, sensor, or other input device coupled with an LED indicator or other light, and/or another output device. The user interface 622 may be used by a user of the hub 600 to power the hub 600 on and off. One or both of a visual indication and an audio indication may confirm that the hub 600 is powered on and ready to be paired with a Bluetooth® -enabled device, or to receive a command. For example, if the user interface 622 comprises a light, the light may illuminate or may turn from one color (e.g. red) to another (e.g. green). Additionally or alternatively, the processor 604 may cause the speaker 616 to play a predetermined audio sequence indicating that the hub 600 is ready to be paired with a Bluetooth®-enabled device or to receive a command, such as “Ready to pair” or “Yes, master?”, respectively. The user interface 622 may thus be used to facilitate pairing of the hub 600 with a Bluetooth®-enabled device as well as to provide the user with a visual indication of a status of the hub 600.

In some embodiments, the hub 600 may be configured to enter a low power or “sleeping” state when powered on but not in use. In such embodiments, the hub 600 may be configured to “wake up” upon receipt of a command via the Bluetooth® transceiver 612. Once the hub 600 awakens, the hub 600 may remain awake for a predetermined period of time (e.g. fifteen seconds, or thirty seconds, or forty-five seconds, or a minute). The predetermined period of time may commence immediately after the hub 600 is awakened, or it may commence (or restart) once a command is received.

The wireless transceiver 624 comprises hardware that allows the hub 600 to control one or more lighting devices, by transmitting and receiving commands and data to and from the one or more lighting devices. The wireless transceiver 624 may also, in some embodiments, transmit audio signals to a speaker 616 (e.g., in embodiments where the speaker 616 is external to and separate from the hub 600). The primary function of the wireless transceiver 624 is to interact with a wireless receiver or transceiver in communication with one or more lighting devices installed in or on the vehicle in which the hub 600 is being used. The wireless transceiver 624 therefore eliminates the need to route wiring from such lighting devices (which wiring may be on the exterior of the vehicle) to a control panel inside the vehicle and within reach of the vehicle operator, and further eliminates any aesthetic drawbacks of such wiring. Instead, the hub 600 can establish a wireless connection with a given lighting device using the wireless transceiver 624, which connection may be used to transmit commands to turn the lighting device's lights on and off, and/or to control other features of the lighting system (e.g., flashing sequence, position, orientation, color). As noted above, the wireless transceiver 624 may also be used for transmitting data (e.g., audio signals) to a speaker 616.

The wireless transceiver 624 may comprise a Wi-Fi card, a Network Interface Card (NIC), a cellular interface (e.g., antenna, filters, and associated circuitry), an NFC interface, an RFID interface, a ZigBee interface, a FeliCa interface, a MiWi interface, a Bluetooth® interface, a BLE interface, or the like. In some embodiments, the functions of the Bluetooth® transceiver 612 and the wireless transceiver 624 may be combined, so that a single device (which may comprise only a Bluetooth® interface or a Bluetooth® interface in combination with one or more interfaces configured to utilize a different wireless communication protocol) handles communications with a Bluetooth®-enabled mobile device as well as communications with one or more lighting devices installed in or on the vehicle in question and, in some embodiments, communications with a speaker 616.

The memory 628 may correspond to any type of non-transitory computer-readable medium. In some embodiments, the memory 628 may comprise volatile or non-volatile memory and a controller for the same. Non-limiting examples of memory 628 that may be utilized in the hub 600 include RAM, ROM, buffer memory, flash memory, solid-state memory, or variants thereof.

The memory 628 stores any firmware 632 needed for allowing the processor 604 to operate and/or communicate with the various components of the hub 600, as needed. The firmware 632 may also comprise drivers for one or more of the components of the hub 600. In addition, the memory 628 stores a command processing module 636 comprising instructions that, when executed by the processor 604, allow the processor 604 to recognize and/or interpret one or more commands received via the Bluetooth® transceiver 612, which commands can then be carried out by the processor 604. Further, in some embodiments the memory stores a speech module 640 comprising instructions that, when executed by the processor 604, allow the processor 604 to provide spoken information to an operator of the hub 600.

In some embodiments, the commands generated by a Bluetooth®-enabled mobile device and transmitted to the processor 604 may be in executable form, such that no command processing module 636 is needed. Also in some embodiments, the command processing module 636 may be utilized to convert signals received from the processor 604 into an appropriate format (or to generate signals in an appropriate format based on signals received from the processor 604) for controlling one or more lighting devices installed in or on the vehicle in question. Such a function may be particularly useful where not all of the one or more lighting devices are controllable using the same signals or the same signal format.

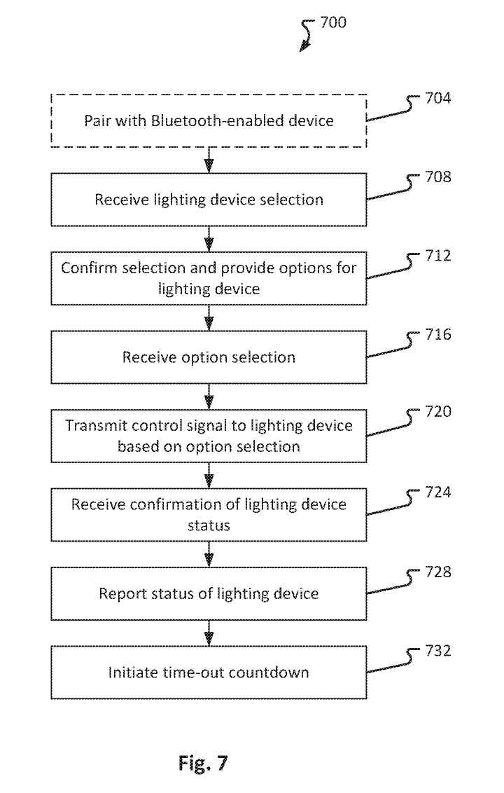

With reference now to FIG. 7, a Bluetooth®-enabled lighting control hub 600 according to the present disclosure may be operated according to a method 700. In the following description of the method 700, reference may be made to actions or steps carried out by the hub 600, even though the action or step is carried out only by a specific component of the hub 600.

With the hub 600 powered on, a user may utilize the user interface 622 of the hub 600 to pair the hub 600 with a Bluetooth®-enabled device (step 704). The pairing may be accomplished in any manner known in the art, and may involve placing one or both of the hub 600 and the Bluetooth®-enabled mobile device in a “discoverable” mode. The pairing may also involve entering a code provided by one of the hub 600 and the Bluetooth®-enabled mobile device on the other of the hub 600 and the Bluetooth®-enabled mobile device, or confirming that a code displayed or otherwise communicated on one of the Bluetooth®-enabled mobile device and the hub 600 is the same as a code displayed or otherwise communicated on the other of the Bluetooth®-enabled mobile device and the hub 600. The pairing may also involve the transmission of one or more signals from the hub 600 to the Bluetooth®-enabled mobile device and/or vice versa, which signals may comprise or complete a “handshake” between the hub 600 and the Bluetooth®-enabled device. In some embodiments, the pairing may only need to be accomplished once, after which the Bluetooth®-enabled mobile device and the hub 600 will connect automatically when within range of each other and powered on. In other embodiments, the pairing may need to be repeated, whether occasionally or each time a user desired to connect the Bluetooth®-enabled mobile device to the hub 600.

Once the Bluetooth®-enabled mobile device and the hub 600 are paired, the hub 600 may receive a selection of a lighting device or of the hub 600 from the Bluetooth®-enabled mobile device (step 708). For example, a user of the Bluetooth®-enabled mobile device may execute an app or other program comprising instructions for execution by a processor of the Bluetooth®-enabled mobile device. When executed, the instructions may cause a graphical user interface to be displayed to the user, through which graphical user interface the user may select an available lighting device (or the hub 600) to control. The selection causes the Bluetooth®-enabled mobile device to send a signal to the hub 600, which signal is received by the Bluetooth® transceiver 612 of the hub 600.

In some embodiments, the Bluetooth®-enabled mobile device may transmit an initial signal to the hub 600 when the app or other program is opened, to ensure that the hub 600 is powered on and ready to receive and execute commands, and the hub 600 may send a confirming signal in reply. If no confirming signal is received, then the app or other program may display an error message to the user, indicating the hub 600 is not available. If the hub 600 is powered on but in a low-power state when the signal is received, then the hub 600 may “wake up” out of the low power state, in response to the signal, so as to be ready to receive a subsequent command. Upon receipt of the signal, the hub 600 may also request instructions. For example, the hub 600 may cause the speaker 616 to play—or may send a signal to the Bluetooth®-enabled mobile device, upon receipt of which the app or other program may in turn cause a speaker of the Bluetooth®-enabled mobile device to play—a computer-generated voice asking, for example, “Yes, master?”. Other words or phrases may also be used, including, for example, “What would you like to do?” or “Ready.” In some embodiments, the request may be replaced or supplemented by a simple indication that the hub 600 is ready to receive a command, such as by changing the color of an indicator light provided with the user interface 622, or by generating an audible beep using the speaker 616, or by transmitting a signal to the Bluetooth®-enabled mobile device that causes the app or other program on the Bluetooth®-enabled mobile device to display or otherwise communicate to a user an indication that the hub 600 is connected and/or powered on and/or ready to receive a command.

Upon receipt of the lighting device (or hub 600) selection, the hub 600 confirms the selection and, in some embodiments, provides options for the selected lighting device (or for the hub 600) (step 712). In some embodiments, the processor 604 retrieves from the memory 628 information about the current status of the selected device and available options or settings for the selected device, and causes the Bluetooth® transceiver 612 to transmit a signal to the Bluetooth®-enabled mobile device that causes the app or other program to display some or all of such information to a user of the Bluetooth®-enabled mobile device. For example, the app or other program may display to the user the current status of the selected device. The app or other program may alternatively display a presentation to the user of options associated with the selected device that are available to be selected by the user. For example, a given lighting device may not only be switchable between on and off, but may also have various modes of operation, such as “steady” (which causes the lighting device to illuminate with a constant light output (e.g., to remain on with no changes in color or intensity)), “music” (which causes the lighting device to emit light that pulsates and/or changes color according to the beat of music being played, whether from the Bluetooth®-enabled mobile device, the vehicle in which the lighting device is installed, or elsewhere), “flash” (which causes the lighting device to alternately emit light at different intensities, or to alternately turn on and off), and/or “rainbow” (which causes the lighting device to emit light that changes over time from one color to another, whether randomly or in a fixed pattern). A given lighting device may also be fixed to a movable mount comprising one or more drive motors, so that the position and/or orientation of the lighting device can be moved by operating the one or more drive motors. Options associated with such a lighting device may include or correspond to changing the position and/or orientation of the lighting device. Another option that may be available for some lighting devices is an option to change the intensity of the light emitted by the lighting device. For example, a user may wish to cause a lighting device to emit a low intensity light at night, and a higher intensity light during the day.

In some embodiments, the hub 600 may confirm the selection (and, in some embodiments, provide options for the selected device) by causing the speaker 616 to play—or by sending a signal to the Bluetooth®-enabled mobile device, upon receipt of which the app or other program may cause a speaker of the Bluetooth®-enabled mobile device to play—a computer-generated voice describing the current status of the selected lighting device and/or the other available statuses or options or settings of the selected lighting device. For example, if the user selects “accent light” in step 704, then an available speaker may be caused to play a voice stating “Yes, master. Accent light here. Do you want steady, music, flash, or rainbow?” Alternatively, if the user selects “headlights” in step 704, and the headlights are currently on, then an available speaker may be caused to play a voice stating “The headlights are on. Would you like high-beams?” or “You selected headlights. Would you like to activate high-beams or turn the headlights off?” As evident from these examples, the hub 600 (or the app or other program) may be programmed to adopt a conversational tone with a user (e.g. by using full sentences and responding to each command with an acknowledgment (e.g. “yes, master”) before requesting additional input. Alternatively, the hub 600 (or the app or other program) may be programmed only to convey information. In such an embodiment, the hub 600 may say, for example, “Accent light. Steady, music, flash, or rainbow?” or “Headlights on. High-beams or off?”

Regardless of whether the hub 600 causes any options to be audibly communicated to a user, available options for a selected device may be displayed to the user via the Bluetooth®-enabled mobile device. In some embodiments, the hub 600 may be programmed to automatically turn on a selected lighting device, so that a user does not have to select a lighting device and then make a separate selection to turn on that lighting device.

The hub 600 next receives an option selection from the Bluetooth®-enabled mobile device (step 716). As with the initial selection of a device, selection of an option for a selected lighting device (or for the hub 600) is accomplished by the user through the Bluetooth®-enabled mobile device, and in some embodiments through a graphical user interface of an app or other program being executed by a processor of the Bluetooth®-enabled mobile device. For example, if the selected device is an accent light and the available options are steady, music, flash, rainbow, change orientation, change position, and change intensity, the user may select, through the app or other program executing on the Bluetooth®-enabled mobile device, any one of these options. Once the selection is made, the app or other program may cause the Bluetooth®-enabled mobile device to transmit a signal to the hub 600 that corresponds to the selected option.

Once the hub 600 has received an option selection at step 716, the hub 600 executes any computer-readable code or instructions corresponding to the selected option, which causes the hub 600 to transmit a control signal to the selected lighting device based on the selected option (if the selected device is a lighting device), or to adjust its own settings (if the selected device is the hub 600) (step 720). For example, if the selected option for a selected lighting device is “flash,” the hub 600 may transmit a wireless signal to a receiver in electronic communication with the accent light, instructing the accent light to flash. If the selected option is “music,” the hub 600 may transmit a wireless signal to a receiver in electronic communication with the accent light instructing the accent light to pulsate according to the beat of music being played by the vehicle's entertainment or infotainment system (or, alternatively, on the Bluetooth®-enabled mobile device). If the selected option is “high beams” for the headlights, then the hub 600 may transmit a wireless signal to a receiver in electronic communication with the headlights, instructing the headlights to switch from low-beams to high-beams. The hub 600 may also be configured to recognize compound option selections. For example, a user may select multiple options, such as “change color” and “flash,” which may cause the hub 600 to transmit a wireless signal to a receiver in electronic communication with the selected lighting device (e.g., an accent light) that instructs the selected lighting device to change to the next color in sequence (or, in some embodiments, to a selected color) and to begin flashing.

After transmitting a control signal to the selected lighting device corresponding to the selected option in step 720, the hub 600 waits to receive a confirmation signal from the lighting device (step 724). The confirmation signal may be a generic acknowledgment that a command was received and carried out, or it may be a more specific signal describing the current state of the lighting device (e.g. on, off, high-beam, low-beam, flashing on, flashing off, color red, color green, color purple, color blue, music, steady, rainbow, intensity level, position description, orientation description).

The hub 600 reports to the Bluetooth®-enabled mobile device by sending, via the Bluetooth® transceiver 612, one or more signals corresponding to the status of the lighting device from which the confirmation signal was received (or, if a setting of the hub 600 was changed, one or more signals corresponding to the updated status of the hub 600) (step 728). Upon receipt of the one or more signals at the Bluetooth®-enabled mobile device, the app or other program may cause information obtained via the signals or corresponding to the signals to be displayed to the user (e.g., via a graphical user interface). In some embodiments, the report may also be provided in spoken format via the speaker 616 (or via a speaker of the Bluetooth®-enabled mobile device) using a computer-generated voice. Such a spoken report may comprise, for example, a statement similar to the command, such as “flashing” or “accent light steady.” Alternatively, the spoken report may be more generic, such as “command executed.” In still another alternative, the spoken report may give the present status of a lighting device in question, such as “the accent light is now red” or “the accent light is now green.” These same statements, or similar statements, may be displayed on a screen of the Bluetooth®-enabled mobile device. In some embodiments, the user may have the option to turn spoken reporting on or off, and/or to select the type of reporting (e.g., visual, spoken, generic, detailed) the user desires to receive.

After reporting the status of the lighting device in step 728, the hub 600 initiates a time-out countdown (step 732). This may comprise initiating a countdown timer, or it may comprise any other known method of determining or tracking when a predetermined period of time has expired. If the time-out countdown concludes without receiving any additional input from the user via the Bluetooth®-enabled mobile device, then the hub 600 may, in some embodiments, return to a low-power sleeping mode. If the user does provide additional input before the time-out countdown concludes, then the hub 600 repeats the appropriate portion of the method 700 (e.g. beginning at step 708 if the additional input is a light device selection or at step 716 if the additional input is an option selection for the previously selected lighting device).

In some embodiments of the present disclosure, a voice-activated lighting control hub according to embodiments of the present disclosure may not include a user interface 622, but may instead allow all user interaction to occur via the Bluetooth®-enabled mobile device.

According to alternative embodiments of the present disclosure, the hub 600 may include a microphone, and may be programmed or otherwise configured to receive and respond to audio commands in addition to commands received via the Bluetooth® transceiver 612 from a Bluetooth®-enabled mobile device. An audio command in such embodiments may include (1) an identification of the lighting device having a state that the commanding user would like to change; and (2) an identification of the change the user would like to make. This two-pronged format may not be needed or utilized where the hub 600 controls only one lighting device, and/or where the lighting device in question has only two possible states (e.g. on/off). However, if for example the hub 600 controls a plurality of lighting devices (e.g. fog lamps, underbody accent lights, and a roof-mounted light bar), and where one or more of the lighting devices may be controlled in more ways than just being turned on and off (e.g. by changing an intensity of a light of the lighting device, a direction in which the lighting device is pointed, an orientation of the lighting device, a flashing sequence of the lighting device, a color of the light emitted from the lighting device, a position of the lighting device (e.g. raised/lowered)), the two-pronged format for audio commands may be useful or even necessary.

As evident from the foregoing discussion, in addition to receiving input intended for control of a lighting device, the voice-activated lighting control hub 600 may also be configured to receive signals from the Bluetooth®-enabled mobile device corresponding to control of the hub 600 itself. For example, before the hub 600 can transmit commands to a lighting device, the hub 600 may need to be paired with or otherwise connected to the lighting device. The hub 600 may therefore receive signals containing or corresponding to instructions that cause the hub 600 to enter a discoverable mode, or that cause the hub 600 to pair with another device in a discoverable mode, or that cause the hub 600 to record connection information for a particular lighting device.

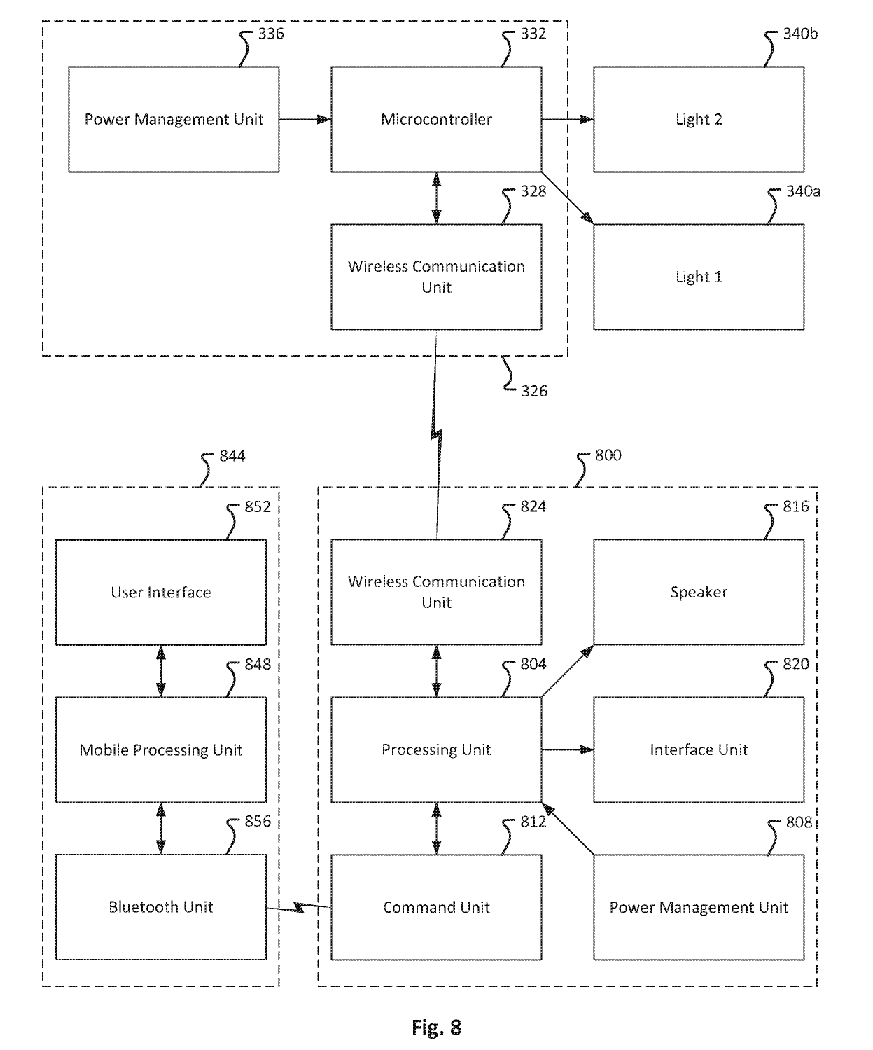

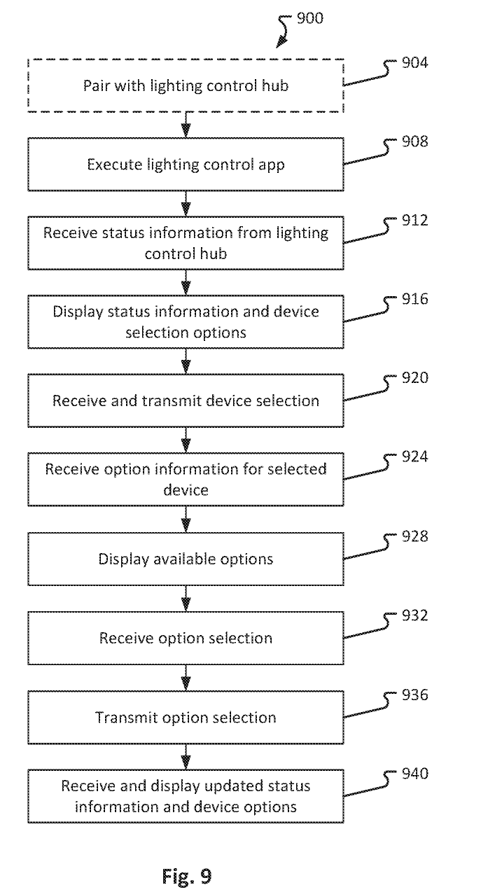

Turning now to FIG. 8, a Bluetooth®-enabled lighting control hub 800 according to yet another embodiment of the present disclosure comprises a processing unit 804, a power management unit 808, a command unit 812, a speaker 816, an interface unit 820, and a wireless communication unit 824. The voice-activated lighting control hub 800 communicates wirelessly with both a receiver 326 (as described above with respect to FIG. 3) and a Bluetooth®-enabled mobile device 844 (comprising a mobile processing unit 848, a user interface 852, and a Bluetooth® unit 856). The receiver 326 may be connected (via a wired or wireless connection) to one or more lights 340a, 340b (also described above with respect to FIG. 3).

The processing unit 804 may comprise, for example, a processor coupled with a memory. The processor may be identical or similar to the processor 604 described in connection with FIG. 6 above. Likewise, the memory may be identical or similar to the memory 628 described in connection with FIG. 6 above. The memory may store instructions for execution by the processor, including instructions for analyzing digital signals received from the command unit 812, identifying one or more operations to conduct based on an analyzed digital signal, and generating and transmitting signals to one or more of the Bluetooth®-enabled mobile device 844, the speaker 816, the interface unit 820, and the wireless communication unit 824. The memory may also store instructions for execution by the processor that allow the processor to generate signals corresponding to a computer-generated voice (e.g. for playback by the speaker 816), for communication of information or of prompts to a user of the hub 800. The memory may further store information about the lights 340a, 340b that may be controlled using the hub 800.

The power management unit 808 handles all power-related functions for the hub 800. These functions include receiving power from a power source (which may be, for example, a vehicle 12-volt power receptacle; an internal or external battery; or any other source of suitable power for powering the components of the hub 800), and may also include transforming power signals to provide an appropriate output voltage and current for input to the speech recognition unit 804 (for example, from a 12-volt, 10 amp received power signal to a 5-volt, 1 amp output power signal), and/or conditioning an incoming power signal as necessary to ensure that it meets the power input requirements of the speech recognition unit 804. The power management unit 808 may also comprise a battery-powered uninterruptible power supply, to ensure that the output power signal thereof (e.g. the power signal input to the speech recognition unit 804) does not vary with fluctuations in the received power signal (e.g. during engine start if the power signal is received from a vehicle's 12-volt power receptacle).

The command unit 812 receives signals, from the Bluetooth®-enabled mobile device 844, comprising or corresponding to commands and/or instructions for operation of the hub 800 and/or of one or more lights 340a, 340b. The command unit 812 comprises a Bluetooth® transceiver for enabling communications, via the Bluetooth® protocol, with the mobile device 844. The Bluetooth® transceiver may be identical or similar to the Bluetooth® transceiver 612 described above.

The speaker 816 may be identical or similar to the speaker 616 described in connection with FIG. 6 above. The speaker 816 may be used for playback of a computer-generated voice based on signals generated by the processing unit 804, and/or for playback of one or more non-verbal sounds (e.g. beeps, buzzes, or tones) at the command of the processing unit 804. The speaker 816 may thus be used to convey information to the user regarding the hub 800 and/or one or more lights 340a, 340b. Any information conveyed to the user via the speaker 816 may, however, additionally or alternatively be communicated to the user via the command unit 812 and the mobile device 844.

The hub 800 may in some embodiments comprise an interface 820, which may comprise, for example, an LED indicator. The processing unit 804 may cause the LED indicator to illuminate with one or more colors, flashing sequences, and/or intensities to provide one or more indications to a user about the hub 800. For example, the LED indicator may display a red light when the hub 800 is in a low power sleep mode, and may switch from red to green to indicate to a user that the hub 800 has awakened out of the low power sleep mode and is ready to receive a command from a paired Bluetooth®-enabled device (e.g., the mobile device 844). Indications provided via the interface unit 820 may or may not be accompanied by playback of a computer-generated voice by the speaker 816. For example, when the hub 800 wakes up out of a low power sleep mode, the LED indicator may change from red to green and the processing unit 804 may cause a computer-generated voice to be played over the speaker 816 that says “yes, master?” As another example, the LED indicator 820 may flash a green light when it is processing a command, and may change from a low intensity to a high intensity when executing a command.

Each of these actions may be taken in addition to or instead of causing the command unit 812 to transmit a signal to the mobile device 844 that causes or results in the mobile device 844 displaying or otherwise communicating the same or similar information to a user thereof. Alternatively, in some embodiments the hub 800 may not comprise an interface unit 820, and all communications between the hub 800 and the user may be routed through the mobile device 844.

In some embodiments, the interface unit 820 may comprise a touch key, which may be depressed by a user to awaken the hub 800 out of a low power sleep mode, and/or to return the hub 800 to a low power sleep mode. In such embodiments, the mobile device 844 may additionally or alternatively be used to accomplish these functions. Similarly, in embodiments without a touch key, the hub 800 may be configured to awake from a lower power sleep mode upon receipt of a signal from the mobile device 844 via the command unit 812, and to return to a low power sleep mode at the command of the mobile device 844 (received via a signal received at the command unit 812) or after a predetermined amount of time has passed since receipt of a command or other signal from the mobile device 844.

The hub 800 also includes a wireless communication unit 824, which may be identical or similar to the wireless transceiver 624 described in connection with FIG. 6 above.

Like the hub 300, the hub 800 communicates wirelessly with a receiver 326, which is described above in connection with FIGS. 3 and 5. In some embodiments, where a single receiver 326 is connected to a plurality of lights 340a, 340b, the mobile device 844 may be used to transmit a single command or signal to the command unit 812. The command or signal may cause the processing unit 804 to in turn cause the wireless communication unit 824 to transmit a signal to the receiver 326, which signal may cause the receiver 326 to send a “turn on” command to all lights 340a, 340b controlled by that receiver 326. Alternatively, where a car uses a plurality of receivers 326 to control a plurality of lights 340a, 340b in and on the vehicle, a command or signal received from the mobile device 844 may be used to cause the hub 800 to send a “turn off” command to each receiver 326, which command may then be provided to each light 340a, 340b attached to each receiver 326. In other embodiments, each light 340a, 340b must be controlled independently, regardless of whether the lights 340a, 340b are connected to the same receiver 326.

The hub 800 also communicates wirelessly, using a Bluetooth® protocol, with the Bluetooth®-enabled mobile device 844. The Bluetooth®-enabled mobile device 844 comprises a mobile processing unit 848 that, like the processing unit 804, comprises a processor operably connected to a memory. The processor may be identical or similar to the processor 604 described in connection with FIG. 6 above. Likewise, the memory may be identical or similar to the memory 628 described in connection with FIG. 6 above. The memory may store instructions for execution by the processor, including instructions for analyzing digital signals received from via the Bluetooth® unit 856, identifying one or more operations to conduct based on an analyzed digital signal, and generating and transmitting signals via the Bluetooth® unit 856 to the command unit 812 of the hub 800. Some or all of such instructions may be part of an app or other program stored in the memory.

The user interface 852 of the mobile device 844 may comprise any user input device and any output device, or any combination thereof. For example, the user interface 852 may be a touchscreen that both receives user inputs and displays information (whether as text, or via a graphical user interface, or otherwise) to the user. As another example, the user interface 852 may comprise a user input device (such as a keyboard, a numeric keypad, one or more buttons, a trackball, a touchpad, or a trackpoint or clit mouse), and a separate display (such as an LCD screen, an LED screen, an OLED screen, an AMOLED screen, a Super AMOLED screen, a TFT screen, an IPS screen, a TFT-LCD screen, or any other known variety of screen). The user interface 852 may be used to display information to a user regarding the status of the hub 800, the status of one or more lights 340a, 340b, one or more options or settings available with respect to the hub 800 and/or the one or more lights 340a, 340b, and any other information useful to or regarding the operation of the hub 800 to control one or more lights 340a, 340b. The user interface 852 may also be used to receive user selections of a light 340a, 340b to control, and/or to receive user selections of one or more options for a selected light 340a, 340b. The user interface 852 may also be used to receive user input needed to pair the mobile device 844 with the hub 800, and/or to configure the hub 800.

The Bluetooth® unit 856 of the mobile device 844 may be any wireless communication interface capable of transmitting signals to and receiving signals from the command unit 812 of the hub 800, using any iteration of the Bluetooth® specification, including but not limited to Bluetooth® 5.0 and/or Bluetooth® Low Energy (BLE). The signals transmitted and received via the Bluetooth® unit 856 may comprise or correspond to instructions for the operation of the hub 800 and/or of one or more lights 340a, 340b, as well as data or instructions regarding or corresponding to the status of the hub 800 and/or of the lights 340a, 340b, available options or settings with respect to the hub 800 and/or the lights 340a, 340b, and any other data or instructions relevant to the operation and use of the hub 800.

The methods of operation of the hub 800 may be the same as or similar to the methods of operation of the hub 600, as described in FIG. 7, and may include any other applicable step corresponding to the disclosure herein.

In a method 900 according to one embodiment of the present disclosure, a mobile device 844 pairs with a hub 800 using a Bluetooth® protocol (step 904). The pairing may be initiated by the mobile device 844 or by the hub 800. The pairing may occur using any known pairing procedure. Once the mobile device 844 and the hub 800 are paired, one or both of the mobile device 844 and the hub 800 may remember the pairing information, so that step 904 need not be repeated each time the mobile device 844 is used to control the lighting control hub 800.

The mobile device 844 executes a lighting control app (step 908). The lighting control app comprises instructions that enable the mobile processing unit 848, and specifically the processor of the mobile processing unit 848, to display appropriate information to the user of the mobile device 844 (e.g., via a graphical user interface), to transmit appropriate instructions to the hub 800, and to properly interpret information received from the hub 800. The lighting control app may be stored, for example, in a memory of the mobile processing unit 848. The lighting control app may initiate automatically when the mobile device 844 is paired to the hub 800, or the lighting control app may initiate in response to a user instruction provided through the user interface 852 of the mobile device 844.

The lighting control app comprises instructions that cause the mobile device 844 to receive status information from the lighting control hub 800 via the Bluetooth® unit 856 (step 912). The status information may be received from the lighting control hub 800 in response to the pairing of the hub 800 with the mobile device 844, or in response to a signal transmitted by the mobile device 844 (via the Bluetooth® unit 856) when the lighting control app is executed on the mobile device 844. The status information may include information about a status of the lighting control hub 800 itself, and/or information about a status of the one or more lights 340a, 340b controllable by the lighting control hub 800. For example, the status information may comprise information about the status of connections between the hub 800, the receiver 326, and the one or more lights 340a, 340b (which connections may be wired or wireless). The status information may comprise information about the status of the one or more lights 340a, 340b, including whether the lights 340a, 340b are on or off and, for any lights that are illuminated, the mode of operation of such lights (e.g., steady, flash, music, rainbow) or other information about such lights (e.g., position, orientation, intensity). The status information may also comprise information about available options or settings for one or more of the hub 800, the receiver 326, and the lights 340a, 340b. Such options or settings may include options relating to connecting the hub 800 to the receiver 326 and/or to another similar receiver; options relating to whether the hub 800 will provide feedback/status information solely via the mobile device 844 or, alternatively, through a speaker 816 and/or interface unit 820 of the hub 800 in addition to or instead of through the mobile device 844; options related to specific lights 340a, 340b (e.g., steady, flashing, music, rainbow, position change, orientation change, intensity change); and options relating to lighting “packages,” e.g., predetermined combinations of settings or configurations for a plurality of lights 340a, 340b that can be initiated with a single command or set as a default light configuration (such as, for example, a “night” package in which headlights are set to on, fog lamps are set to on, underbody accent lights are set to low-intensity blue, and a roof-mounted light bar is set to off; or an “everything on” package in which headlights are set to on, fog lamps are set to on, underbody accent lights are set to rainbow, grill lights are set to on, a roof-mounted light bar is set to on, and all lights are set to high intensity; or a “music” package in which underbody accent lights are set to music and rainbow, and grill lights and a roof-mounted light bar are set to music).

The mobile device 844, through the user interface 852, displays status information and device selection options to the user (step 916). This display allows the user to see the current status of the hub 800, the receiver 326, and/or the lights 340a, 340b, and further allows the user to see which devices may be selected (and thus controlled) from the mobile device 844.

The mobile device 844, again through the user interface 852, receives a device selection from the user, and transmits a signal corresponding to the device selection to the hub 800 via the Bluetooth® unit 856 (step 920). The selected device may be the hub 800, the receiver 326, or a light 340a, 340b.

In some embodiments, available options for the hub 800, the receiver 326, and for each of the lights 340a, 340b that are controllable through the hub 800 are stored in the memory of the mobile processing unit 848. In other embodiments, the available options for the hub 800, the receiver 326, and the lights 340a, 340b are received from the hub 800 each time the mobile device 844 and the hub 800 are paired. In still other embodiments, the mobile device 844 receives the available options for a selected hub 800, receiver 326, or light 340a, 340b once the hub 800, the receiver 326, or the light 340a, 340b is selected (step 924). The available options may include any of the options discussed above or other options relating to the control of the hub 800, the receiver 326, and/or the lights 340a, 340b.

The available options are displayed to the user by the mobile device 844, through the user interface 852 (step 928). In some embodiments, all of the options for the selected device may be displayed to a user, with options that are currently selected highlighted or otherwise identified. For example, if a user selects headlights, and the headlights are currently on with high beams off, the mobile device 844 may display to the user, through the user interface 852, the options “headlights on,” “headlights off,” “high beams on,” and “high beams off,” with the “headlights on” and “high beams off” options highlighted as reflecting the current status of the headlights. In such embodiments, the user is able to see all of the available options as well as the current status of the selected device at once. In other embodiments, the mobile device 844 may display to the user, through the user interface 852, only those options that are not already selected (from which the current status of the device may be inferred). Thus, if the user selects headlights that are currently on with high beams off, the mobile device 844 may display to the user the options “headlights off” and “high beams on.”

The mobile device 844 receives the user's option selection(s) through the user interface 852 (step 932). The user may select one option at a time, or multiple options at a time.

The mobile device 844 transmits the user's option selection(s) to the hub 800 via the Bluetooth® unit 856 (step 936). In some embodiments, the mobile device 844 transmits all selections made by the user at once, after the user confirms that all desired selections have been made. In other embodiments, the mobile device 844 transmits each selection made by the user to the hub 800 as the selection is made. Upon receipt of the selection(s) (whether individually or all at once), the hub 800 carries out the selected options. When the option selections relate to the hub 800, the processing unit 804 processes instructions corresponding to the option selections so as to implement the selected options. When the option selections relate to the receiver 326, the hub 800 transmits appropriate signals to the receiver 326 via the wireless communication units 824 and 328, and the microcontroller 332 of the receiver 326 receives the signals and processes instructions contained in or corresponding to the signals so as to implement the selected options. When the option selections relate to a light 340a, 340b, the hub 800 transmits appropriate signals to the receiver 326 via the wireless communication units 824 and 328, and the microcontroller 332 of the receiver 326 receives the signals and processes instructions contained in or corresponding to the signals, which instructions cause the microcontroller 332 to send appropriate signals to the lights 340a, 340b for implementing the selected options.

The mobile device 844 receives (via the Bluetooth® unit 856) and displays (via the user interface 852) updated status information and device options (step 940). This allows the user to confirm that the user's option selections were implemented, and also allows the user to make any additional desired option selections.

It should be appreciated that the embodiments of the present disclosure need not be connected to the Internet or another wide-area network to conduct speech recognition or other functions described herein. The hubs 600 and 800 have stored in a computer-readable memory therein the data and instructions necessary to recognize and process verbal instructions.

A number of variations and modifications of the foregoing disclosure can be used. It would be possible to provide for some features of the disclosure without providing others. Features of one embodiment disclosed herein may be incorporated into another embodiment disclosed herein without departing from the scope of the present disclosure.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARM926EJ-S™ processors. A processor as disclosed herein may perform computational functions using any known or future-developed standard, instruction set, libraries, and/or architecture.

I claim:

1. A lighting control hub, comprising:
a command unit comprising a Bluetooth transceiver;
a processing unit comprising a processor and a computer-readable memory storing instructions for execution by the processor;
a wireless communication unit; and
a power management unit configured to provide power to at least the processing unit in a first low-power sleep mode and in a second operational mode,
wherein the instructions, when executed by the processor, cause the processor to:
recognize an input;
exit the first low-power sleep mode and enter the second operational mode;
process signals received via the command unit;
generate a control signal responsive to the processed instructions; and
transmit the control signal via the wireless communication unit.

2. The lighting control hub of claim 1, wherein the input is received via the command unit.

3. The lighting control hub of claim 1, wherein the signals received via the command unit correspond to one or more settings of the lighting control hub.

4. The lighting control hub of claim 1, wherein the instructions, when executed by the processor, further cause the processor to:
transmit, via the command unit, information about an initial status of at least one lighting device.

5. The lighting control hub of claim 1, wherein the instructions, when executed by the processor, further cause the processor to:
receive, via the command unit, a selection signal identifying a selected lighting device from a plurality of lighting devices,
and further wherein the signals received via the command unit correspond to the selected lighting device.

6. The lighting control hub of claim 5, wherein the control signal corresponds to a command to change a status of the selected lighting device.

7. The lighting control hub of claim 6, wherein the status corresponds to one of a power state of the lighting device, a color of light generated by the lighting device, a flashing sequence of the lighting device, a position of the lighting device, an orientation of the lighting device, and an intensity of light generated by the lighting device.

8. The lighting control hub of claim 1, wherein the power management unit comprises a 12-volt adapter for connection of the lighting control hub to a 12-volt power receptacle.

9. The lighting control hub of claim 1, further comprising an LED indicator, wherein the instructions, when executed by the processor, further cause the processor to:
provide an indication, via the LED indicator, that the lighting control hub is in the second operational mode.

10. A method of controlling a lighting device, comprising:
establishing a communication channel, via a Bluetooth transceiver of a lighting control hub, between the lighting control hub and a mobile device;
receiving, via the Bluetooth transceiver, a first signal corresponding to a selection of a lighting device controllable by the lighting control hub;
transmitting, via the Bluetooth transceiver, a second signal comprising information about a plurality of available options for the selected lighting device;
receiving, via the Bluetooth transceiver, a third signal corresponding to a selection of at least one option from the plurality of available options;
generating, with a processor of the lighting control hub, a control signal based on the at least one option; and
transmitting the control signal to the selected lighting device.

11. The method of claim 10, wherein the lighting device is one of a plurality of lighting devices controllable by the lighting control hub.

12. The method of claim 10, wherein the plurality of available options comprises an option corresponding to at least one of a power state of the lighting device, a color of light generated by the lighting device, a flashing sequence of the lighting device, and an intensity of light generated by the lighting device.

13. The method of claim 10, wherein the plurality of available options comprises an option corresponding to at least one of a position of the lighting device, an orientation of the lighting device.

14. The method of claim 10, wherein the lighting device is controllable by the lighting control hub via a receiver in electronic communication with the lighting device.

15. The method of claim 14, wherein the lighting control hub transmits the control signal to the selected lighting device via the receiver, and further wherein the lighting control hub transmits the control signal to the receiver wirelessly.

16. The method of claim 15, wherein the lighting control hub transmits the control signal to the receiver wirelessly via a wireless communication interface separate from the Bluetooth transceiver.

17. The method of claim 10, further comprising transmitting, via the Bluetooth transceiver, a fourth signal corresponding to a status of the lighting device.

18. A lighting control system for a vehicle, comprising:
a hub comprising:
a processor;
a non-transitory computer-readable memory storing instructions for execution by the processor;
a Bluetooth transceiver; and
a first wireless transceiver; and
a receiver comprising:
a microcontroller;
a second wireless transceiver; and
a lighting device interface,
wherein the instructions for execution by the processor, when executed by the processor, cause the processor to:
receive, via the Bluetooth transceiver, a signal corresponding to a desired setting of a lighting device connected to the lighting device interface;
generate a control signal, based on the signal, for adjusting the lighting device to have the desired setting; and
cause the first wireless transceiver to transmit the control signal to the second wireless transceiver.

19. The lighting control system of claim 18, wherein the at desired setting corresponds to one or more of a power state of the lighting device, a color of light generated by the lighting device, a flashing sequence of the lighting device, a position of the lighting device, an orientation of the lighting device, and an intensity of light generated by the lighting device.

20. The lighting control system of claim 18, wherein the microcontroller comprises a second processor and a second computer-readable memory storing second instructions for execution by the second processor, wherein the second instructions, when executed by the second processor, cause the second processor to:
receive the control signal via the second wireless transceiver;
send, via the lighting device interface, a command signal based on the control signal; and
transmit a confirmation signal via the second wireless transceiver, wherein the confirmation signal comprises a present status of a lighting device connected to the lighting device interface.
